(19) United States
(12) Patent Application Publication
(10) Pub. No.: US 2017/0092003 A1
(43) Pub. Date: Mar. 30, 2017

(54) Applying Augmented Reality to an Object

(71) Applicant: Schlumberger Technology Corporation, Sugar Land, TX (US)

(72) Inventors: Seoyeon Hong, Houston, TX (US); Garud Bindiganavale Sridhar, Sugar Land, TX (US); Jijo Oommen Joseph, Houston, TX (US)

(21) Appl. No.: 14/870,804

(22) Filed: Sep. 30, 2015

(51) Int. Cl. G06T 19/00; G06T 7/00; G06K 9/62

(52) U.S. Cl. CPC G06T 19/006; G06K 9/6215; G06T 7/0008; G06T 2200/04; G06T 2207/30108

(57) ABSTRACT

The present disclosure introduces apparatus and methods for identifying discrepancies of oilfield wellsite equipment relative to computer-generated models. A captured image of a component of a physical object is obtained. A planar model image of the component is obtained employing a preexisting, three-dimensional (3-D), computer-generated model. A difference between the captured image and the planar model image is identified with respect to a point of interest of the component. A discrepancy report is produced for the difference.

### BACKGROUND OF THE DISCLOSURE

Operations performed at oilfield wellsites may include drilling, cementing, acidizing, water jet cutting, and hydraulic fracturing of subterranean formations, among other examples. During the manufacture and/or installation and/or maintenance/repair of components and assemblies utilized during such oilfield operations, or even during the operations, the components may be verified against an engineering model. In current practice, the component and/or assembly is manually compared against a two-dimensional (“2-D”) drawing. However, such a manual process is prone to error, and generally consumes substantial human capital for its execution. A difficulty of such a comparison is its tendency not to catch many of the errors, which is a result of the final product being in a three-dimensional (“3-D”) space, whereas the model and drawing that are used for the comparison are in a two-dimensional space.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces a method of operating a discrepancy-identifying apparatus that includes a processor and memory. The method includes obtaining a captured image of a component of a physical object, obtaining a planar model image of the component employing a preexisting, three-dimensional (3-D), computer-generated model of the component, and identifying a difference between the captured image and the planar model image with respect to a point of interest of the component. The method also includes producing a discrepancy report for the difference.

The present disclosure also introduces a discrepancy-identifying apparatus that includes a processor and a memory including computer program code. The processor, the memory, and the computer program code are collectively operable to cause the discrepancy-identifying apparatus to obtain a captured image of a component of a physical object, obtain a planar model image of the component employing a preexisting, 3-D, computer-generated model, and identify a difference between the captured image and the planar model image with respect to a point of interest of the component. The processor, the memory, and the computer program code are also collectively operable to cause the discrepancy-identifying apparatus to produce a discrepancy report for the difference.

The present disclosure also introduces a discrepancy-identifying apparatus that includes a processor, a memory including computer program code, an input device operable to capture a digital image of a physical object from a physical viewing orientation of the input device relative to the physical object, and an output device operable to display a discrepancy report. The processor, the memory, and the computer program code are collectively operable to identify the physical object in the digital image captured by the input device as a real-life instance of one of a plurality of 3-D, computer-generated models of different components of oilfield wellsite equipment stored in the memory. The processor, the memory, and the computer program code are also collectively operable to generate a planar model image of the identified one of the plurality of 3-D, computer-generated models from a digital viewing orientation that is substantially the same as the physical viewing orientation of the input device relative to the physical object when the input device captured the digital image of the physical object. The processor, the memory, and the computer program code are also collectively operable to identify a difference between the captured digital image and the generated planar model image, generate the discrepancy report based on the identified difference, and display the discrepancy report on the output device.

These and additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example environment for a discrepancy-identifying apparatus according to one or more aspects of the present disclosure.

FIG. 2 is a side view of an image of a pump assembly employable with a discrepancy-identifying apparatus according to one or more aspects of the present disclosure.

FIG. 3 is a perspective view of a computer-generated solid model planar model image of the pump assembly shown in FIG. 2.

FIG. 4 is a planar model view of the model shown in FIG. 3 from the perspective of the image shown in FIG. 2.

FIG. 5 is a perspective view of a planar model image of a high-pressure manifold associated with a fracturing operation at an oilfield wellsite employable with a discrepancy-identifying apparatus according to one or more aspects of the present disclosure.

FIG. 6 is a schematic view of at least a portion of an example implementation of a discrepancy-identifying apparatus according to one or more aspects of the present disclosure.

FIG. 7 is a flow-chart diagram of at least a portion of an example implementation of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The present disclosure introduces a discrepancy-identifying apparatus operable for producing a discrepancy report for a difference between a captured image of a component of a physical object and a planar model image of the component. In the context of the present disclosure, a planar model image of a component is a planar image of a 3-D, computer-generated model of the component, and the 3-D, computer-generated model of the component exists prior to the execution of methods introduced in the present disclosure, such as a preexisting, 3-D, computer-generated model of the component that may have been generated for engineering, manufacturing, installation, and/or operational purposes. The discrepancy-identifying apparatus may be utilized with various types of equipment utilized at an oilfield wellsite. The physical equipment can be located at the wellsite, stationed at an associated base facility, repaired at an associated maintenance shop, and/or transported between the wellsite, the base facility, and the maintenance shop. In the context of the present disclosure, oilfield wellsites are those from which a wellbore extends into a subterranean, hydrocarbon-containing formation, including those utilized in the exploration and/or production of oil and/or gas natural resources contained within such subterranean formations. One or more aspects of the techniques introduced herein may be utilized to measure quality (in situ quality assurance) in complex components or assemblies, and/or may permit more efficient quality assessment.

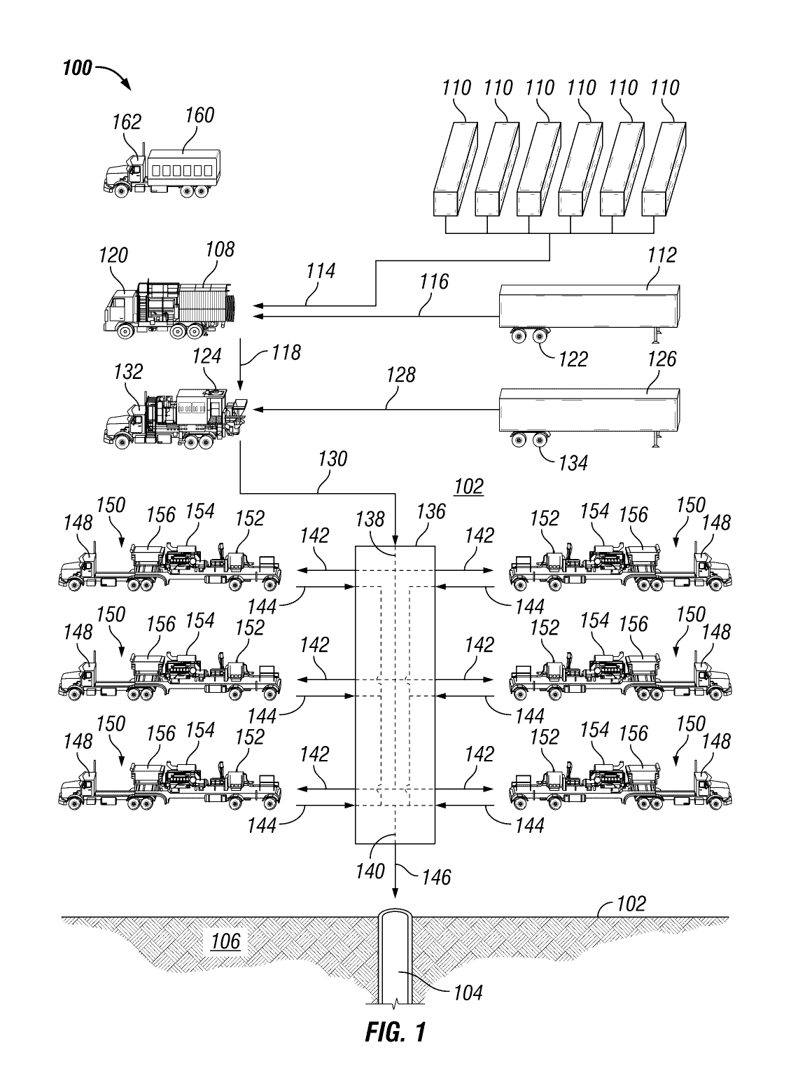

FIG. 1 is a schematic view of at least a portion of an example environment for a discrepancy-identifying apparatus according to one or more aspects of the present disclosure. The figure shows a wellsite system 100 disposed at a wellsite surface 102 adjacent to a wellbore 104, a partial sectional view of a subterranean formation 106 penetrated by the wellbore 104 below the wellsite surface 102, and a plurality of wellsite equipment that may be examined by a discrepancy-identifying apparatus for producing a discrepancy report. The wellsite system 100 may comprise a first mixer 108 fluidly connected with one or more tanks 110 and a first container 112. The first container 112 may contain a first material and the tanks 110 may contain a liquid. The first material may be or comprise a hydratable material or gelling agent, such as guar, polymers, synthetic polymers, galactomannan, polysaccharides, cellulose, and/or clay, among other examples, and the liquid may be or comprise an aqueous fluid, which may comprise water or an aqueous solution comprising water, among other examples. The first mixer 108 may be operable to receive the first material and the liquid via two or more fluid conduits 114, 116, and mix or otherwise combine the first material and the liquid to form a base fluid. The base fluid may be or comprise that which is known in the art as a gel. The first mixer 108 may then discharge the base fluid via one or more fluid conduits 118.

The first mixer 108 and the first container 112 may each be disposed on corresponding trucks, trailers, and/or other mobile carriers 120, 122, respectively, such as may permit their transportation to the wellsite surface 102. However, the first mixer 108 and/or first container 112 may be skidded or otherwise stationary, and/or may be temporarily or permanently installed at the wellsite surface 102.

The wellsite system 100 may further comprise a second mixer 124 fluidly connected with the first mixer 108 and a second container 126. The second container 126 may contain a second material that may be substantially different than the first material. For example, the second material may be or comprise a proppant material, such as sand, sand-like particles, silica, quartz, and/or propping agents, among other examples. The second mixer 124 may be operable to receive the base fluid from the first mixer 108 via one or more fluid conduits 118, and the second material from the second container 126 via one or more fluid conduits 128, and mix or otherwise combine the base fluid and the second material to form a mixture. The mixture may be or comprise that which is known in the art as a fracturing fluid. The second mixer 124 may then discharge the mixture via one or more fluid conduits 130.

The second mixer 124 and the second container 126 may each be disposed on corresponding trucks, trailers, and/or other mobile carriers 132, 134, respectively, such as may permit their transportation to the wellsite surface 102. However, the second mixer 124 and/or second container 126 may be skidded or otherwise stationary, and/or may be temporarily or permanently installed at the wellsite surface 102.

The mixture may be communicated from the second mixer 124 to a common manifold 136 via the one or more fluid conduits 130. The common manifold 136 may comprise a plurality of valves and diverters, as well as a suction line 138 and a discharge line 140, such as may be operable to direct flow of the mixture in a selected or predetermined manner. The common manifold 136, which may be known in the art as a missile or a missile trailer, may distribute the mixture to a pump fleet, which may comprise a plurality of pump assemblies 150, each comprising a pump 152, a prime mover 154, and a heat exchanger 156. Each pump assembly 150 may receive the mixture from the suction line 138 of the common manifold 136, via one or more fluid conduits 142, and discharge the mixture under pressure to the discharge line 140 of the common manifold 136, via one or more fluid conduits 144. The mixture may then be discharged from the common manifold 136 into the wellbore 104 via one or more fluid conduits 146, perhaps through various valves, conduits, and/or other hydraulic circuitry fluidly connected between the common manifold 136 and the wellbore 104.

The pump assemblies 150 may each be mounted on corresponding trucks, trailers, and/or other mobile carriers 148, such as may permit their transportation to the wellsite surface 102. However, the pump assemblies 150 may be skidded or otherwise stationary, and/or may be temporarily or permanently installed at the wellsite surface 102. Although the pump fleet of the wellsite system 100 is shown comprising six pump assemblies 150, the pump fleet may comprise other quantities of pump assemblies 150 within the scope of the present disclosure.

The wellsite system 100 may also comprise a control center 160, which may be operable to provide control to one or more portions of the wellsite system 100. The control center 160 may be further operable to monitor health, functionality, and/or other operational characteristics of one or more portions of the wellsite system 100. Control signals may be communicated between the control center 160 and other wellsite equipment via electric conductors (not shown). However, other means of signal communication, such as wireless communication, are also within the scope of the present disclosure.

The control center 160 may be disposed on a corresponding truck, trailer, and/or other mobile carrier 162, such as may permit its transportation to the wellsite surface 102. However, the control center 160 may be skidded or otherwise stationary, and/or may be temporarily or permanently installed at the wellsite surface 102.

The first mixer 108, the second mixer 124, the tanks 110, the first container 112, the second container 126, the common manifold 136, the pump assemblies 150, and the control center 160 (hereinafter collectively referred to as “wellsite equipment”) are collectively operable to produce and/or mix fluids that may be pressurized and injected into the wellbore 104 during hydraulic fracturing of the subterranean formation 106. However, it is to be understood that the discrepancy-identifying apparatus for producing the discrepancy report within the scope of present disclosure may be utilized with and operable for producing the discrepancy report for wellsite equipment utilized during other oilfield operations, such as drilling, cementing, acidizing, chemical injecting, and/or water jet cutting operations, among other examples.

As introduced herein, an image of a physical object such as a mechanical assembly, which is inherently a 3-D device, is compared against a corresponding image produced by a preexisting, 3-D, computer-generated model. A discrepancy report is produced from the comparison using augmented reality (“AR”) technology. The result reduces inaccuracy and the likelihood of errors in the comparison process that would otherwise be produced by human effort, and consumes substantially less human input than is now employed in current practice.

The process employing a preexisting, 3-D, computer-generated model can be applied, without limitation, to a manufacturing operation and a field operation. A discrepancy report for the manufactured product or field installation or operation is thereby automatically produced.

During a manufacturing operation for inspection of an assembly, instead of using 2-D drawings to compare against the manufactured or installed product, a preexisting, 3-D, computer-generated model resident in memory containing software is employed and actuated by an electronic processor for the comparison to achieve better accuracy. A discrepancy report is automatically created based on comparing a digitally acquired 2-D image with the preexisting, 3-D, computer-generated model.

As an example during a field operation at an oilfield wellsite, augmented reality technology is employed to assess and monitor the current status of the field operation on a real-time basis. The technology is used to read the flow of fluids and sensor values from different gauges to detect an abnormal operating condition. The physical arrangement can also be assessed. The read values for fluid flows and sensor values are compared against a preexisting, 3-D, computer-generated model that provides a range of normal operating conditions and sensor values. A field version of a discrepancy report is produced.

One example application of the comparison process is to use augmented reality technology to check the assembly of a bridle of a fracturing pump employed at an oilfield wellsite, such as of the pump assemblies 150 shown in FIG. 1. More specifically, during a manufacturing process of such a bridle assembly, for example at the discharge end of a triplex or quintuplex pump, verifying that discharge pipes on each side of a fluid end of the pump are installed with the same angles and lengths is useful to prevent failures in the field. However, such verification is often not accurately accomplished due to the difficulty of measuring angles in the field at a large scale. If the angles of discharge pipes are not the same, it can cause a weakness in a T-section of the bridle. Service quality incidents frequently occur that are caused by misalignment of suction and discharge pipes of a bridle assembly. When highly pressurized fluids are pumped through the weak points, a failure frequently occurs.

The present disclosure introduces a photographic technique employed to compare a manufactured or installed component with a virtual reality produced from a preexisting, 3-D, computer-generated model. In this manner, human errors and other problems are detected to identify discrepancies.

As an example of producing a discrepancy report, the chamfer of an edge is assessed. The observed chamfer captured in a 2-D image is so many degrees or a certain radius, and the chamfer observed in the preexisting, 3-D, computer-generated model occupies a different number of degrees or a different radius. The difference is then reported in the discrepancy report.

The model uses augmented reality technology that overlays virtual graphics on top of physical objects. This can be achieved by adding overlays on top of a captured image or video of the physical object using an image-capturing device of, for instance, a tablet computer. The system will track the position of the image-capturing device in relation to the physical object. A first approach is to use physical identification markers that can be tracked by the image-capturing device. A second approach is to track identifiable points on the physical object itself, such as corners, edges, and/or other characteristic features. The tablet computer may comprise a number of internal sensors, such as may include a magnetometer, a gyroscope, and/or an accelerometer. Using combined values from these sensors, the orientation of the image-capturing device can be determined to an acceptable degree of accuracy. If this orientation is considered relative to a coordinate origin in a 3-D space, and a common forward direction (as determined by the direction the image-capturing device is facing when the application is launched), one can use the device orientation to define a reference frame that is the same while the application is still running. If both frames (of the captured image of the physical object and the 3-D, computer-generated model) are measured relative to this reference frame, then the discrepancy between them can be determined.

In application, an operator is positioned in front of a physical object and takes one or more 2-D images, generally from multiple locations around the physical object, with an electronic image-capturing device, such as may reside in a digital camera. Images are electronically laid one on top of the other to compare the 2-D images with the preexisting, 3-D, computer-generated model.

Images of gauges and sensor devices may also be captured and compared to expected values produced from preexisting, 3-D, computer-generated models, such as to monitor system performance in real time. Areas of wear, corrosion, or damage can also be observed and identified. The devices that are assessed can be as manufactured, as maintained, or as modified, and can be applied to a wide range of products.

In the digitally-captured image, a number of points of interest are identified. Mathematical values are assigned to the points/pixels in the digitally-captured image. Differences are identified based on the observed mathematical values of the points (e.g., pixel(s)) in the digitally-captured image.

In field operations, gauges and sensors that are now employed have a cost and reliability associated with them. Employing augmented reality that operates in conjunction with preexisting, 3-D, computer-generated models reduces the need for a sensor to wirelessly transmit data to a central server and the associated costs and reliability issues.

The images can be captured by drones equipped with a digital image-capturing device in difficult settings such as at an offshore wellsite. The captured images are processed with software that goes back to engineering or manufacturing drawings or models to identify discrepancies.

The preexisting, 3-D, computer-generated models may reside in a digital camera having a digital image-capturing device and/or a digital video-capturing device. Software in the digital camera can perform the comparison in real time with the preexisting, 3-D, computer-generated models.

In some implementations, the preexisting, 3-D, computer-generated models are compressed so they can reside in a mobile or easily transportable device, even a wearable device. The software can be customized for different components of a physical object to determine the points of interest.

Thus, augmented reality technology is employed to assess a 2-D image of a manufactured or installed device that is captured with an image-capturing device and compared against a planar model image produced utilizing a preexisting, 3-D, computer-generated model. The planar model image produced utilizing the preexisting, 3-D, computer-generated model is employed to identify faults and other operational parameters to analyze the device and/or an operation thereof. An automated discrepancy report can be produced for corrective action by a technician or a robot.

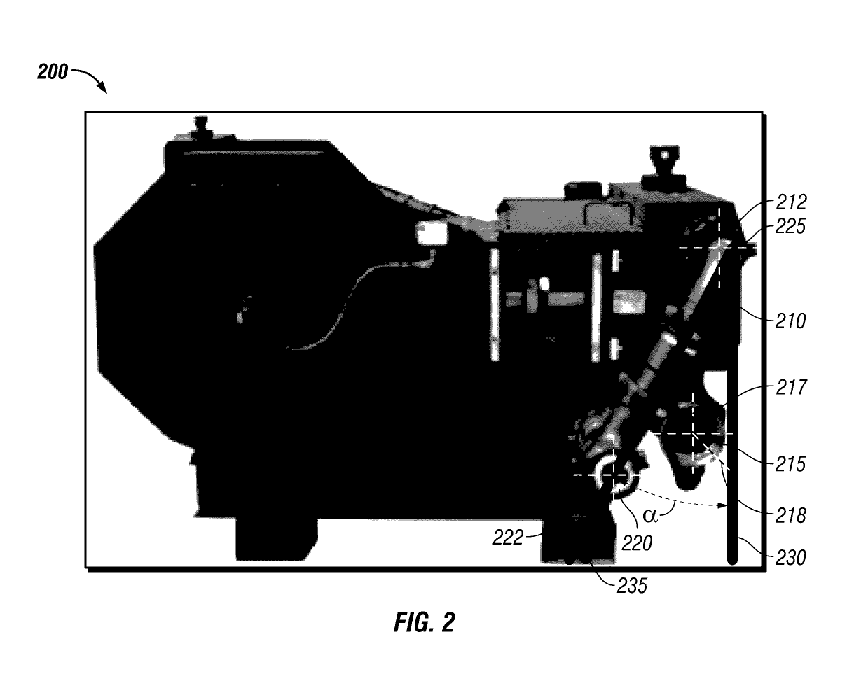

FIG. 2 is a side view of an image 200 of a pump assembly employable with a discrepancy-identifying apparatus according to one or more aspects of the present disclosure. The pump assembly may form at least a portion of the pump assembly 150 introduced above with respect to FIG. 1. The image 200 may be captured with an image-capturing device resident in a digital camera, a mobile telephony device, or a wearable device. The image 200 illustrates a discharge angle α of discharge pipes 210, 215, and 220 of the pump assembly, which is assessed after installation by employing augmented reality according to aspects of the present disclosure. In a wellsite field operation, accurately measuring such a discharge angle α is often not easily or accurately performed. Applying augmented reality technology to the image 200 of the pump assembly provides a quick and accurate assessment of such a discharge angle α of the discharge pipes.

Various features are depicted in FIG. 2 to aid in clarity of the present description. For example, FIG. 2 depicts a centerline 212 of the upper end of the pipe 210 that, if projected forward (towards the reader), coincides with the apex 225 of the lines 230 and 235 oriented at the discharge angle α. FIG. 2 also depicts a centerline 217 of the pipe 215 that, if projected forward (e.g., along dashed line 218) from the open end of the pipe 215, coincides with the line 230. Thus, the line 230 extends between the centerline 212 of the upper end of the pipe 210 and the centerline 217 of the open end of the pipe 215. Similarly, FIG. 2 also depicts a centerline 222 of the pipe 220 that coincides with the line 235, such that the line 235 extends between the centerline 212 of the upper end of the pipe 210 and the centerline 222 of the open end of the pipe 220. The augmented reality version of the image 200 may include just the lines 230 and 235, or may also include the depiction of the discharge angle α, or may also include the centerlines 212, 217, and 222, and perhaps forward projections from the centerlines 212, 217, and 222, such as the projection line 218.

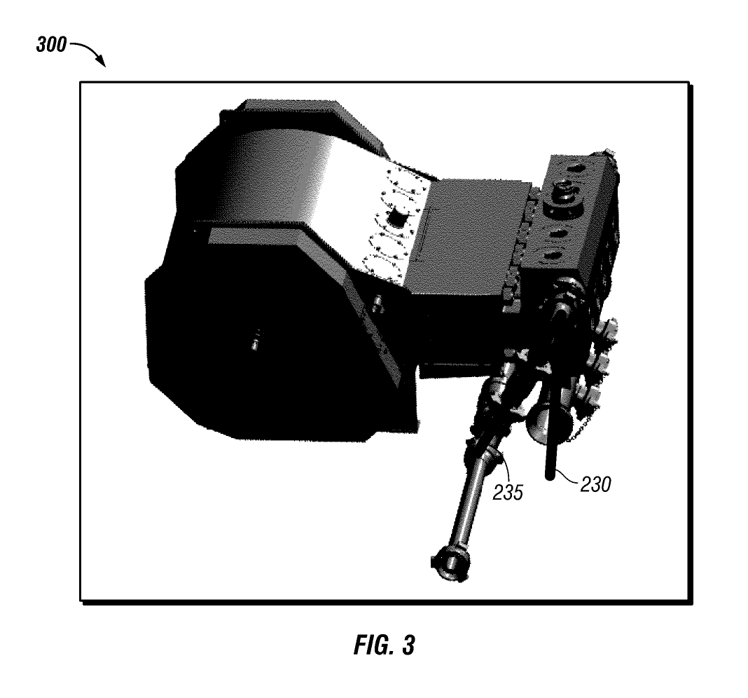

FIG. 3 is a perspective view of a preexisting, 3-D, computer-generated model 300 of the pump assembly shown in FIG. 2 and illustrates the mechanical complexity thereof. FIG. 3 also depicts the lines 230 and 235 shown in FIG. 2. However, such depiction is merely to provide a frame of reference relative to the image 200 shown in FIG. 2. The model 300 may not actually include the lines 230 and 235.

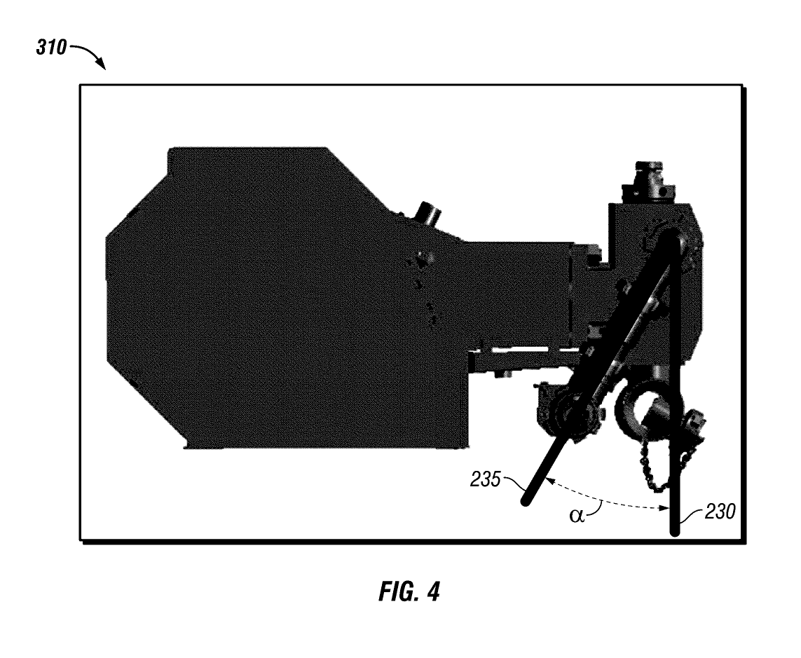

FIG. 4 is a planar model image 310 of the pump assembly of FIG. 2. The planar model image 310 is obtained from the preexisting, 3-D, computer-generated model 300. The discrepancy-identifying apparatus as disclosed herein can compare the image 200 of the pump assembly with the planar model image 310 to produce a discrepancy report. If angles, lengths, and/or other dimensions do not match within a manufacturing tolerance, the discrepancy-identifying apparatus based on the augmented reality technology can flag an installer to correct the pump assembly. The discrepancy-identifying apparatus is adept at estimating a viewing direction of the image 200 and obtaining the planar model image 310 employing the viewing direction to accurately ascertain discrepancies.

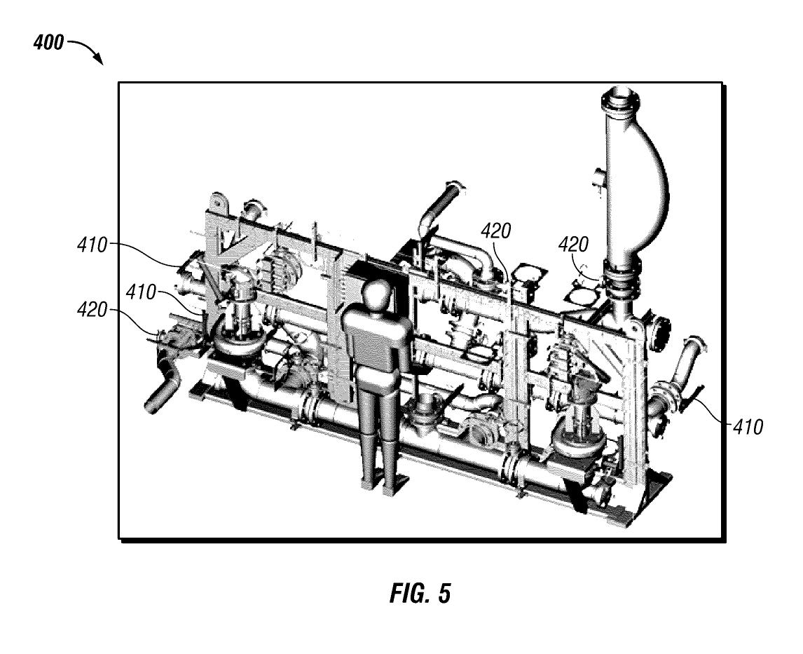

FIG. 5 is a perspective view of a planar model image 400 of a high-pressure manifold associated with a fracturing operation at an oilfield wellsite employable with a discrepancy-identifying apparatus according to one or more aspects of the present disclosure. The planar model image 400 is obtained from a preexisting, 3-D, computer-generated model of the high-pressure manifold. In this application of the augmented reality technology, actuator positions, gauge values, and/or sensor values of the high-pressure manifold are monitored in real time during a cementing operation, for example. During the cementing operation, a field installer can use the discrepancy-identifying apparatus as disclosed herein to verify that the actuator positions, gauge values, and/or sensor values are maintained within normal operating limits in real time. The discrepancy-identifying apparatus compares modeled gauge/sensor values, fluid flows, and positions of actuators against installed and operating values (from a captured image of the high-pressure manifold) and creates a discrepancy report therefrom. Example actuators depicted in FIG. 5 are designated by reference number 410, and example pressure gauges/sensors are designated by reference number 420.

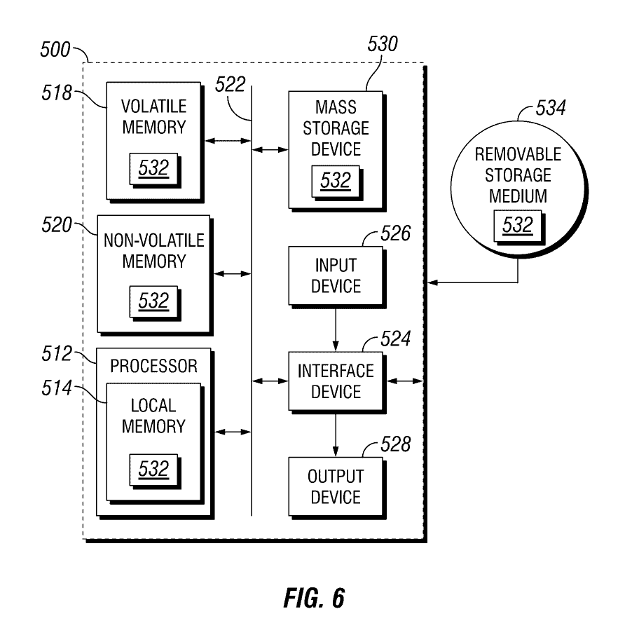

FIG. 6 is a schematic view of at least a portion of a discrepancy-identifying apparatus according to one or more aspects of the present disclosure. The discrepancy-identifying apparatus is or comprises a processing system 500 that may execute example machine-readable instructions to implement at least a portion of one or more of the methods and/or processes described herein, and/or to implement at least a portion of a discrepancy-identifying apparatus for producing a discrepancy report described herein. The processing system 500 may be or comprise, for example, one or more processors, controllers, special-purpose computing devices, servers, personal computers, tablet computers, personal digital assistant (“PDA”) devices, smartphones, internet appliances, and/or other types of computing devices. Moreover, while it is possible that the entirety of the processing system 500 shown in FIG. 6 is implemented within the discrepancy-identifying apparatus for producing the discrepancy report, it is also contemplated that one or more components or functions of the processing system 500 may be external to the processing system 500.

The processing system 500 may comprise a processor 512 such as, for example, a general-purpose programmable processor. The processor 512 may comprise a local memory 514, and may execute coded instructions 532 present in the local memory 514 and/or another memory device. The processor 512 may execute, among other things, machine-readable instructions or programs to implement the methods and/or processes described herein. The programs stored in the local memory 514 may include program instructions or computer program code that, when executed by an associated processor, enable surface equipment at the wellsite to perform tasks as described herein. The processor 512 may be, comprise, or be implemented by one or a plurality of processors of various types suitable to the local application environment, and may include one or more of general- or special-purpose computers, microprocessors, digital signal processors (“DSPs”), field-programmable gate arrays (“FPGAs”), application-specific integrated circuits (“ASICs”), and processors based on a multi-core processor architecture, as non-limiting examples. Other processors from other families are also appropriate.

The processor 512 may be in communication with a main memory, such as may include a volatile memory 518 and a non-volatile memory 520, perhaps via a bus 522 and/or other communication means. The volatile memory 518 may be, comprise, or be implemented by random access memory (“RAM”), static random access memory (“SRAM”), synchronous dynamic random access memory (“SDRAM”), dynamic random access memory (“DRAM”), RAMBUS dynamic random access memory (“RDRAM”) and/or other types of random access memory devices. The non-volatile memory 520 may be, comprise, or be implemented by read-only memory, flash memory and/or other types of memory devices. One or more memory controllers (not shown) may control access to the volatile memory 518 and/or the non-volatile memory 520.

The processing system 500 may also comprise an interface circuit and/or other interface device 524. The interface device 524 may be, comprise, or be implemented by various types of standard interfaces, such as an Ethernet interface, a universal serial bus (“USB”), a third generation input/output (“3GIO”) interface, a wireless interface, and/or a cellular interface, among others. The interface device 524 may also comprise a graphics driver card. The interface device 524 may also comprise a communication device such as a modem or network interface card to facilitate exchange of data with external computing devices via a network (e.g., Ethernet connection, digital subscriber line (“DSL”), telephone line, coaxial cable, cellular telephone system, satellite, etc.).

One or more input devices 526 may be connected to the interface device 524. The input device(s) 526 may permit a user to enter data and commands into the processor 512. The input device(s) 526 may be, comprise, or be implemented by, for example, a keyboard, a mouse, a touchscreen, a track-pad, a trackball, an isopoint, and/or a voice recognition system, among others. The input device(s) 526 may comprise an image-capturing device configured to capture an image of a component of a physical object to identify a difference between the captured image and a planar model image of the component with respect to a point of interest of the component.

One or more output devices 528 may also be connected to the interface device 524. The output devices 528 may be, comprise, or be implemented by, for example, display devices (e.g., a liquid crystal display or cathode ray tube display (“CRT”), among others), printers, and/or speakers, among others.

The processing system 500 may also comprise one or more mass storage devices 530 for storing machine-readable instructions and data. Examples of such mass storage devices 530 include floppy disk drives, hard drive disks, compact disk (“CD”) drives, and digital versatile disk (“DVD”) drives, among others. The coded instructions 532 may be stored in the mass storage device 530, the volatile memory 518, the non-volatile memory 520, the local memory 514, and/or on a removable storage medium 534, such as a CD or DVD. Thus, the modules and/or other components of the processing system 500 may be implemented in accordance with hardware (embodied in one or more chips including an integrated circuit such as an ASIC), or may be implemented as software or firmware for execution by a processor. In particular, in the case of firmware or software, the embodiment can be provided as a computer program product including a computer readable medium or storage structure embodying computer program code (i.e., software or firmware) thereon for execution by the processor.

The discrepancy-identifying apparatus introduced herein includes the processor 512 and memory (e.g., the memory 514) including computer program code (e.g., the coded instructions 532) that cause the discrepancy-identifying apparatus to identify a component of a physical object and identify a point of interest of the component. The discrepancy-identifying apparatus also obtains a captured image (via an image-capturing input device 526) of the component of the physical object, estimates a viewing direction of the captured image of the component, obtains a planar model image of the component employing a preexisting, 3-D, computer-generated model with respect to the viewing direction, and identifies a difference between the captured image and the planar model image with respect to the point of interest of the component. The estimate of the viewing direction may include a triangulation of points in the preexisting, 3-D, computer-generated model. The preexisting, 3-D, computer-generated model may be produced using software compression technology, and may be based on an engineering design of the component. The discrepancy-identifying apparatus may also identify a manufacturing tolerance of the point of interest of the component, compare the difference to the manufacturing tolerance, and produce a discrepancy report (e.g., in real time) for the difference when the difference exceeds the manufacturing tolerance. The manufacturing tolerance may be based on an engineering design of the component. The discrepancy report may employ a mathematical value of an element (e.g., pixel(s)) in the captured image. The discrepancy report can be employed as a guide to recommend remedial or correction actions for the component of the physical object.

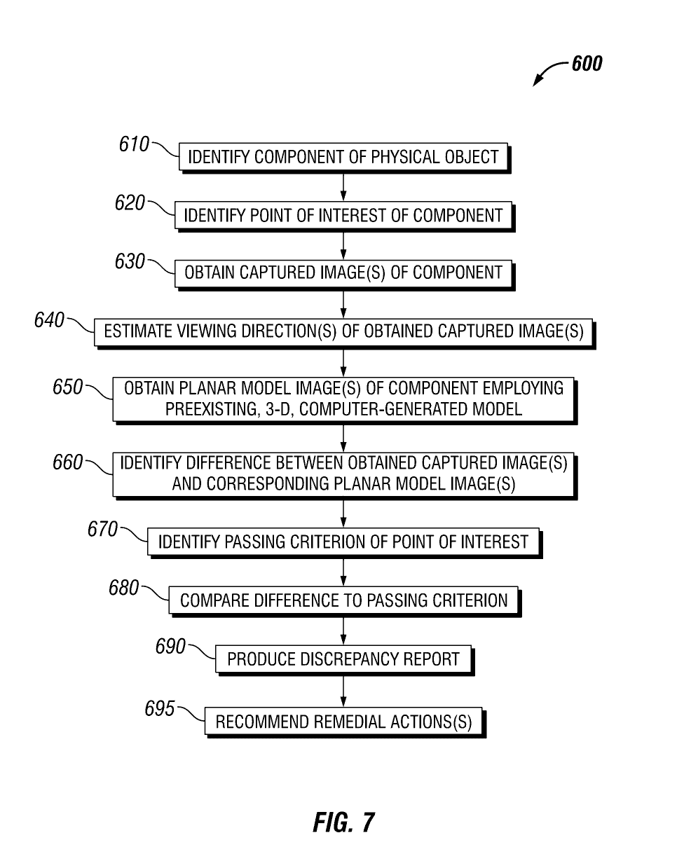

FIG. 7 is a flow-chart diagram of at least a portion of an example implementation of a method (600) according to one or more aspects of the present disclosure. The method (600) may be performed utilizing at least a portion of one or more implementations of the discrepancy-identifying apparatus shown in FIG. 6 and/or otherwise within the scope of the present disclosure, including for producing discrepancy reports pertaining to the wellsite equipment shown in one or more of FIGS. 1-5 and/or otherwise within the scope of the present disclosure.

The method (600) includes identifying (610) a component of a physical object. The component of the physical object may be the discharge of the pump assembly of an oilfield wellsite introduced with respect to FIG. 2, among other examples of applicable oilfield wellsite equipment. The component may be identified for a quality assurance purpose, a maintenance purpose, and/or for life prediction of a field unit.

A point of interest of the identified (610) component is then identified (620). With respect to the pump assembly example of FIG. 2, for example, the identified (620) point of interest may be the angle α of the discharge. As another example, the identified (610) component may include a gauge or sensor of a physical object (e.g., of the high-pressure manifold of FIG. 5), and the identified (620) point of interest may include a reading of the gauge or sensor. The identified (620) point of interest may also be a critical dimension of the identified (610) component.

One or more captured images of the identified (610) component of the physical object are then obtained (630). For example, an image-capturing device resident in a digital camera may capture the image(s). The digital camera, itself, may perform many of the actions described herein.

One or more viewing directions corresponding to the obtained (630) captured image(s) of the identified (610) component are then estimated (640). For example, the viewing direction(s) may be estimated (640) employing triangulating points in a preexisting, 3-D, computer-generated model. The preexisting, 3-D, computer-generated model may be produced based on an engineering design of the component. The preexisting, 3-D, computer-generated model may be compressed using a software compression technology for accessibility on a mobile device and/or other devices.

One or more planar model images of the identified (610) component may then be obtained (650) employing the preexisting, 3-D, computer-generated model with respect to the estimated (640) viewing direction(s) of the obtained (630) captured image(s). Thus, the orientation of the physical object will appear substantially similar (if not identical) in both the obtained (650) planar model image(s) and the obtained (630) captured image(s). Estimating (640) the viewing direction(s) may also include estimating the viewing location relative to the physical object, such that, in addition to the orientation, the size and/or location of the physical object will also appear substantially similar (if not identical) in both the obtained (650) planar model image(s) and the obtained (630) captured image(s). However, in other implementations, the size and/or location of the physical object in the obtained (650) planar model image(s) may be matched to the obtained (630) captured image(s) by simpler means, such as image scaling, cropping, and the like.

A difference between the obtained (630) captured image(s) and the corresponding obtained (650) planar model image(s) is then identified (660) with respect to the identified (620) point of interest of the component. A discrepancy report of the identified (660) difference may then be produced (690).

The method (600) may also comprise identifying (670) a manufacturing tolerance or other passing criterion of the identified (620) point of interest of the component. For example, the identified (670) manufacturing tolerance may be based on an engineering design of the component. The identified (660) difference may then be compared (680) to the identified (670) passing criterion, and the discrepancy report may then be produced (690) when the identified (660) difference exceeds the identified (670) passing criterion. For example, the identified (660) difference may include a difference that is observable between the obtained (630) captured image(s) of the reading of the gauge or sensor and the obtained (650) planar model image(s) with respect to a reading produced via the preexisting, 3-D, computer-generated model. The discrepancy report may be produced (690) employing a mathematical value of an element in the obtained (630) captured image, such as a mathematical value of one or more pixels in the image.

Producing (690) the discrepancy report may be in real time, and may comprise or trigger visually and/or otherwise displaying the discrepancy report via one or more output devices, such as the output device 528 shown in FIG. 6 and described above. For example, producing (690) the discrepancy report, whether in response to the identification (660) of a difference and/or in response to the comparison (680) between an identified (660) difference and an identified (670) passing criterion, may comprise or trigger displaying the discrepancy report on a visual display that was utilized by an operator at the oilfield wellsite to capture the obtained (630) captured image(s) of the component, including real time implementations in which the discrepancy report is so displayed mere moments after the wellsite operator captured the image of the wellsite object/component. Remedial or correction actions for the component of the physical object may also be recommended (695) based on the discrepancy report.

In view of the entirety of the present disclosure, including the figures and the claims, a person having ordinary skill in the art should readily recognize that the present disclosure introduces a method of operating a discrepancy-identifying apparatus including a processor and memory, comprising: obtaining a captured image of a component of a physical object; obtaining a planar model image of the component employing a preexisting, 3-D, computer-generated model of the component; identifying a difference between the captured image and the planar model image with respect to a point of interest of the component; and producing a discrepancy report for the difference.

The method may further comprise identifying the component of the physical object, identifying the point of interest of the component, and acquiring the captured image employing an image-capturing device. The image-capturing device may comprise a digital camera.

The method may further comprise identifying a manufacturing tolerance of the point of interest of the component, and producing the discrepancy report for the difference may be based on a comparison of the difference and the manufacturing tolerance. The manufacturing tolerance may be based on an engineering design of the component.

The method may further comprise estimating a viewing direction of the captured image of the component, and obtaining the planar model image of the component may employ the viewing direction. Estimating the viewing direction may comprise triangulating points in the preexisting, 3-D, computer-generated model.

Producing the discrepancy report may employ a mathematical value of an element in the captured image.

The component may comprise a gauge or sensor, and the point of interest may comprise a reading of the gauge or sensor. In such implementations, the difference may comprise a difference between the captured image of the reading of the gauge or sensor and the planar model image with respect to a reading produced by the preexisting, 3-D, computer-generated model.

Producing the discrepancy report may comprise producing the discrepancy report in real time.

The method may further comprise: obtaining a plurality of captured images of the component; obtaining a plurality of planar model images of the component employing the preexisting, 3-D, computer-generated model; identifying the difference between the plurality of captured images and the plurality of planar model images with respect to the point of interest; and producing the discrepancy report for the difference between the plurality of captured images and the plurality of planar model images with respect to the point of interest.

The preexisting, 3-D, computer-generated model may be produced using software compression technology.

The preexisting, 3-D, computer-generated model may be produced based on an engineering design of the component.

The preexisting, 3-D, computer-generated model may be compressed for accessibility on a mobile device.

The physical object may be wellsite equipment operating at an oilfield wellsite from which a wellbore extends into a subterranean, hydrocarbon-containing formation.

The method may further comprise recommending a remedial action for the component based on the discrepancy report.

The present disclosure also introduces a discrepancy-identifying apparatus comprising: a processor; and a memory including computer program code, wherein the processor, the memory, and the computer program code are collectively operable to cause the discrepancy-identifying apparatus to: obtain a captured image of a component of a physical object; obtain a planar model image of the component employing a preexisting, 3-D, computer-generated model; identify a difference between the captured image and the planar model image with respect to a point of interest of the component; and produce a discrepancy report for the difference.

The processor, the memory, and the computer program code may be further collectively operable to cause the discrepancy-identifying apparatus to: identify the component of the physical object; identify the point of interest of the component; and acquire the captured image employing an image-capturing device. The image-capturing device may comprise a digital camera.

The processor, the memory, and the computer program code may be further collectively operable to cause the discrepancy-identifying apparatus to: identify a manufacturing tolerance of the point of interest of the component; compare the difference to the manufacturing tolerance; and produce the discrepancy report for the difference when the difference exceeds the manufacturing tolerance. The manufacturing tolerance may be based on an engineering design of the component.

The processor, the memory, and the computer program code may be further collectively operable to cause the discrepancy-identifying apparatus to: estimate a viewing direction of the captured image of the component; and obtain the planar model image employing the viewing direction. The estimate of the viewing direction may be based on a triangulation of points in the preexisting, 3-D, computer-generated model.

Production of the discrepancy report may employ a mathematical value of an element in the captured image.

The component may comprise a gauge or sensor and the point of interest may comprise a reading of the gauge or sensor. In such implementations, the difference may comprise a difference between the captured image of the reading of the sensor and the planar model image with respect to a reading produced by the preexisting, 3-D, computer-generated model.

Production of the discrepancy report may be in real time.

The processor, the memory, and the computer program code may be further collectively operable to cause the discrepancy-identifying apparatus to: obtain a plurality of captured images of the component; obtain a plurality of planar model images of the component employing the preexisting, 3-D, computer-generated model; identify the difference between the plurality of captured images and the plurality of planar model images with respect to the point of interest; and produce the discrepancy report for the difference.

The preexisting, 3-D, computer-generated model may be produced using software compression technology.

The preexisting, 3-D, computer-generated model may be produced based on an engineering design of the component.

The preexisting, 3-D, computer-generated model may be compressed for accessibility on a mobile device.

The physical object may be wellsite equipment operating at an oilfield wellsite from which a wellbore extends into a subterranean, hydrocarbon-containing formation.

The processor, the memory, and the computer program code may be further collectively operable to cause the discrepancy-identifying apparatus to recommend a remedial action for the component based on the discrepancy report.

The present disclosure also introduces a discrepancy-identifying apparatus comprising: a processor; a memory including computer program code; an input device operable to capture a digital image of a physical object from a physical viewing orientation of the input device relative to the physical object; and an output device operable to display a discrepancy report, wherein the processor, the memory, and the computer program code are collectively operable to: identify the physical object in the digital image captured by the input device as a real-life instance of one of a plurality of 3-D, computer-generated models of different components of oilfield wellsite equipment stored in the memory; generate a planar model image of the identified one of the plurality of 3-D, computer-generated models from a digital viewing orientation that is substantially the same as the physical viewing orientation of the input device relative to the physical object when the input device captured the digital image of the physical object; identify a difference between the captured digital image and the generated planar model image; generate the discrepancy report based on the identified difference; and display the discrepancy report on the output device.

The input device may comprise a digital camera.

The input device may comprise a digital video camera operable to capture a digital video of operation of the physical object at an oilfield wellsite, and wherein the processor, the memory, the computer program code, and the input device may be collectively operable to capture the digital image of the physical object by selecting a frame of the captured digital video.

The processor, the memory, and the computer program code may be further collectively operable to: access a passing criterion associated with the identified one of the plurality of 3-D, computer-generated models, wherein the passing criterion is stored in the memory; perform a comparison between the identified difference and the accessed passing criterion; and generate the discrepancy report based on the comparison. The passing criterion may be a manufacturing tolerance associated with the identified one of the plurality of 3-D, computer-generated models, and the comparison may be to determine whether the identified difference exceeds the manufacturing tolerance.

The discrepancy report may be displayed on the output device in real time.

The processor, the memory, the input device, and the output device may be integrated in a mobile device.

The discrepancy-identifying apparatus may further comprise a display utilized by the input device when capturing the digital image of the physical object and utilized by the output device to display the discrepancy report.

The processor, the memory, and the computer program code may be further collectively operable to recommend a remedial action for the physical object based on the discrepancy report.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to permit the reader to quickly ascertain the nature of the technical disclosure. It is submitted with the understanding that it will not be used to interpret or limit the scope or meaning of the claims.

What is claimed is:

1. A method of operating a discrepancy-identifying apparatus including a processor and memory, comprising:
obtaining a captured image of a component of a physical object;
obtaining a planar model image of the component employing a preexisting, three-dimensional (3-D), computer-generated model of the component;
identifying a difference between the captured image and the planar model image with respect to a point of interest of the component; and
producing a discrepancy report for the difference.

2. The method of claim 1 further comprising:
identifying the component of the physical object;
identifying the point of interest of the component; and
acquiring the captured image employing an image-capturing device.

3. The method of claim 2 wherein the image-capturing device comprises a digital camera.

4. The method of claim 1 further comprising identifying a manufacturing tolerance of the point of interest of the component, wherein producing the discrepancy report for the difference is based on a comparison of the difference and the manufacturing tolerance.

5. The method of claim 1 further comprising estimating a viewing direction of the captured image of the component, wherein obtaining the planar model image of the component employs the viewing direction.

6. The method of claim 1 wherein producing the discrepancy report employs a mathematical value of an element in the captured image.

7. The method of claim 1 wherein the component comprises a gauge or sensor and the point of interest comprises a reading of the gauge or sensor.

8. The method of claim 7 wherein the difference comprises a difference between the captured image of the reading of the gauge or sensor and the planar model image with respect to a reading produced by the preexisting, 3-D, computer-generated model.

9. The method of claim 1 wherein producing the discrepancy report comprises producing the discrepancy report in real time.

10. The method of claim 1 wherein the preexisting, 3-D, computer-generated model is produced based on an engineering design of the component.

11. The method of claim 1 wherein the preexisting, 3-D, computer-generated model is compressed for accessibility on a mobile device.

12. The method of claim 1 wherein the physical object is wellsite equipment operating at an oilfield wellsite from which a wellbore extends into a subterranean, hydrocarbon-containing formation.

13. The method of claim 1 further comprising recommending a remedial action for the component based on the discrepancy report.

14. A discrepancy-identifying apparatus, comprising:
a processor; and
a memory including computer program code, wherein the processor, the memory, and the computer program code are collectively operable to cause the discrepancy-identifying apparatus to:
obtain a captured image of a component of a physical object;
obtain a planar model image of the component employing a preexisting, three-dimensional (3-D), computer-generated model;
identify a difference between the captured image and the planar model image with respect to a point of interest of the component; and
produce a discrepancy report for the difference.

15. The discrepancy-identifying apparatus of claim 14 wherein the processor, the memory, and the computer program code are further collectively operable to cause the discrepancy-identifying apparatus to:
identify the component of the physical object;
identify the point of interest of the component; and
acquire the captured image employing an image-capturing device.

16. The discrepancy-identifying apparatus of claim 14 wherein the processor, the memory, and the computer program code are further collectively operable to cause the discrepancy-identifying apparatus to:
identify a manufacturing tolerance of the point of interest of the component;
compare the difference to the manufacturing tolerance; and
produce the discrepancy report for the difference when the difference exceeds the manufacturing tolerance.

17. The discrepancy-identifying apparatus of claim 14 wherein the processor, the memory, and the computer program code are further collectively operable to cause the discrepancy-identifying apparatus to:
estimate a viewing direction of the captured image of the component; and
obtain the planar model image employing the viewing direction.

18. A discrepancy-identifying apparatus, comprising:
a processor;
a memory including computer program code;
an input device operable to capture a digital image of a physical object from a physical viewing orientation of the input device relative to the physical object; and
an output device operable to display a discrepancy report, wherein the processor, the memory, and the computer program code are collectively operable to:
identify the physical object in the digital image captured by the input device as a real-life instance of one of a plurality of three-dimensional (3-D), computer-generated models of different components of oilfield wellsite equipment stored in the memory;
generate a planar model image of the identified one of the plurality of 3-D, computer-generated models from a digital viewing orientation that is substantially the same as the physical viewing orientation of the input device relative to the physical object when the input device captured the digital image of the physical object;
identify a difference between the captured digital image and the generated planar model image;
generate the discrepancy report based on the identified difference; and
display the discrepancy report on the output device.

19. The discrepancy-identifying apparatus of claim 18 wherein the processor, the memory, and the computer program code are further collectively operable to:
access a passing criterion associated with the identified one of the plurality of 3-D, computer-generated models, wherein the passing criterion is stored in the memory;
perform a comparison between the identified difference and the accessed passing criterion; and
generate the discrepancy report based on the comparison.

20. The discrepancy-identifying apparatus of claim 18 further comprising a display utilized by the input device when capturing the digital image of the physical object and utilized by the output device to display the discrepancy report.
